(19) United States
(12) Patent Application Publication
(10) Pub. No.: US 2011/0137980 A1
(43) Pub. Date: Jun. 9, 2011

(54) METHOD AND APPARATUS FOR USING SERVICE OF PLURALITY OF INTERNET SERVICE PROVIDERS

(75) Inventors: Sun-bal KIM, Suwon-si (KR); Eun-hee RHIM, Suwon-si (KR); Soon-back CHA, Hwaseong-si (KR); Mun-jo KIM, Suwon-si (KR)

(73) Assignee: SAMSUNG ELECTRONICS CO., LTD., Suwon-si (KR)

(21) Appl. No.: 12/910,441

(22) Filed: Oct. 22, 2010

Related U.S. Application Data
(60) Provisional application No. 61/267,522, filed on Dec. 8, 2009.

(30) Foreign Application Priority Data
Feb. 4, 2010 (KR) 10-2010-0010480

(51) Int. Cl. G06F 15/16

(52) U.S. Cl. 709/203

(57) ABSTRACT

A method and apparatus for using a service of an Internet Service Provider (ISP) from among a plurality of ISPs are provided. The method includes: receiving information regarding a plurality of servers respectively operated by the plurality of ISPs from a server managing information regarding the plurality of ISPs; searching for an ISP which provides Internet access to the client from among the plurality of ISPs by accessing at least one of the plurality of servers according to the received information; and using a service of the ISP which provides the Internet access to the client and is discovered based on the searching.

### CROSS-REFERENCE TO RELATED PATENT APPLICATIONS

This application claims the benefit of U.S. Provisional Patent Application No. 61/267,522, filed on Dec. 8, 2009 in the U.S. Patent and Trademark Office, and priority from Korean Patent Application No. 10-2010-0010480, filed on Feb. 4, 2010 in the Korean Intellectual Property Office, the disclosures of which are incorporated herein in their entirety by reference.

### BACKGROUND

1. Field

Apparatuses and methods consistent with exemplary embodiments relate to a method and apparatus for using a service of an Internet service provider (ISP), and more particularly, to a method and apparatus for using a service of an ISP from among a plurality of ISPs.

2. Description of the Related Art

As various services including an Internet Protocol television (IPTV) service, an information service or the like are provided via the Internet, the number of consumer electronics (CE) devices having an internet connection function embedded therein so as to be able to use the various services has increased.

Services provided via the Internet include a service such as an IPTV service that is provided only to users accessing the Internet via a network managed by an ISP.

### SUMMARY

Exemplary embodiments provide a method and apparatus for using a service of an Internet Service Provider (ISP) from among a plurality of ISPs, and a computer readable recording medium having recorded thereon a program for executing the method.

According to an aspect of an exemplary embodiment, there is provided a method of using a service of an ISP from among a plurality of ISPs, the method performed by a client and including: receiving information regarding a plurality of servers respectively operated by the plurality of ISPs from a server managing information regarding the plurality of ISPs; searching for an ISP providing Internet access to the client from among the plurality of ISPs by accessing the plurality of servers according to the received information; and using a service of the searched ISP providing the Internet access to the client.

The searching may include: sequentially transmitting information regarding the client to the plurality of servers according to the received information; and receiving a message indicating successful authentication of the client from a server of the ISP providing the Internet access to the client, wherein the ISP is from among the plurality of ISPs.

The information regarding the client may include at least one of an Internet Protocol (IP) address of the client, a user identifier (ID), and a Universally Unique ID (UUID).

The using the service may include: receiving a widget for using the service of the searched ISP from the server managing the information regarding the plurality of ISPs; installing the widget; and using the service of the searched ISP according to the widget.

The receiving the widget may include: transmitting information regarding the searched ISP to the server managing the information regarding the plurality of ISPs; receiving a list of a plurality of widgets for using the service of the searched ISP; and sequentially receiving the plurality of widgets according to the list of the plurality of widgets.

The using the service may include: receiving Uniform Resource Locator (URL) information of a webpage related to the service of the searched ISP from a server operated by the searched ISP; and accessing the webpage based on the URL information, and using the service of the searched ISP.

According to an aspect of another exemplary embodiment, there is provided an apparatus for using a service of an ISP from among a plurality of ISPs, the apparatus being implemented in a client and including: an information receiving unit which receives information regarding a plurality of servers respectively operated by the plurality of ISPs from a server managing information regarding the plurality of ISPs; a searching unit which searches for an ISP providing Internet access to the client from among the plurality of ISPs by accessing the plurality of servers according to the received information; and a service using unit which uses a service of the searched ISP providing the Internet access to the client.

According to an aspect of another exemplary embodiment, there is provided a computer readable recording medium having recorded thereon a program for executing the method of using the service.

According to an aspect of another exemplary embodiment, there is provided a method of using a service of an Internet Service Provider (ISP), the method performed by a client and including: receiving information regarding a server operated by the ISP from a server managing information regarding the ISP; determining whether the ISP provides Internet access to the client by accessing the ISP according to the received information; and using a service of the ISP in response to determining that the ISP provides the Internet access to the client.

### BRIEF DESCRIPTION OF THE DRAWINGS

The above and other aspects will become more apparent by describing in detail exemplary embodiments with reference to the attached drawings in which:

FIG. 1 is a diagram of a system for using a service, according to an exemplary embodiment;

FIG. 2 is a flowchart of a method of using a service, according to an exemplary embodiment;

FIG. 3 is a flowchart of a method of using a service, according to another exemplary embodiment;

FIG. 4 is a flowchart of a method of using a service, according to another exemplary embodiment;

FIG. 5 is a flowchart of a method of using a service, according to another exemplary embodiment;

FIG. 6 is a diagram of a client according to an exemplary embodiment;

FIG. 7 is a diagram of a management server according to another exemplary embodiment; and

FIG. 8 is a diagram of an ISP server according to another exemplary embodiment.

### DETAILED DESCRIPTION OF EXEMPLARY EMBODIMENTS

Hereinafter, exemplary embodiments will be described in detail with reference to the attached drawings in which like reference numerals refer to like elements throughout. Expressions such as “at least one of,” when preceding a list of elements, modify the entire list of elements and do not modify the individual elements of the list.

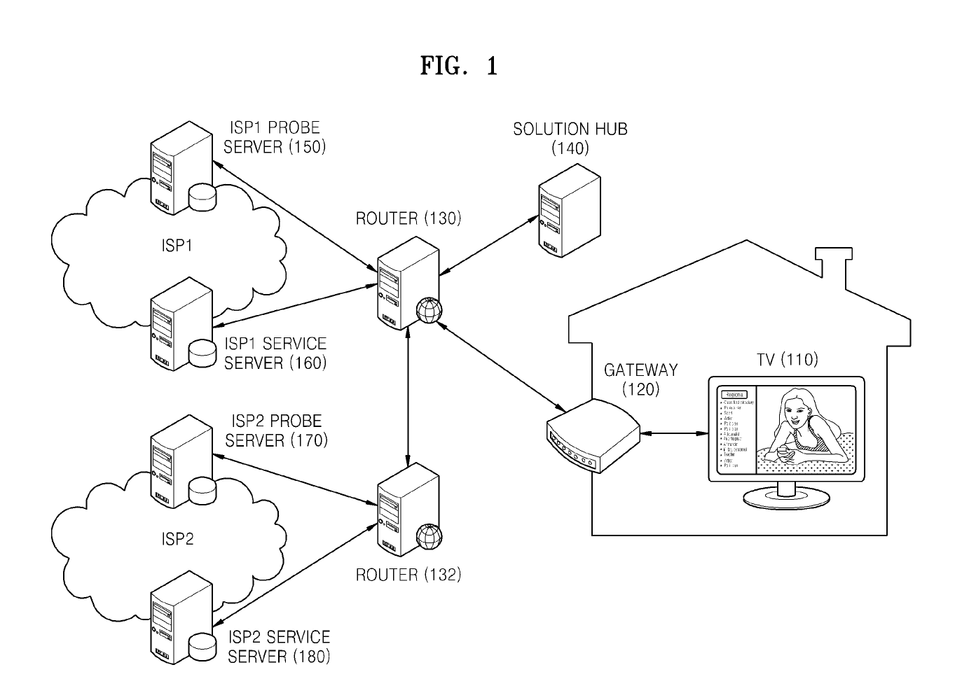

FIG. 1 is a diagram of a system for using a service, according to an exemplary embodiment. Referring to FIG. 1, a client of a home network domain (such as a television (TV) 110) accesses the Internet via a gateway 120. The TV 110 may access the Internet via the gateway 120 and a router 130 of a network of a first ISP (ISP1).

In this regard, when a manufacturer manufactures the TV 110, the manufacturer does not know which ISP's network will be accessed by the TV 110 so as to use a service. Thus, in order to allow a user to use a service of an ISP from among a plurality of ISPs via the TV 110, the TV 110 includes a plurality of pieces of software related to a plurality of ISP services. In other words, in FIG. 1, it is unknown which ISP from among the ISP1 and a second ISP (ISP2) provides Internet access to the TV 110. When the manufacturer manufactures the TV 110, the manufacturer may embed software in the TV 110, wherein the software includes, for example, at least one of a widget, a user interface (UI) and the like capable of accessing all ISPs and using services thereof.

According to an exemplary embodiment, there is provided a method of using a service by selecting an ISP from among the plurality of ISPs providing Internet access to the TV 110. Accordingly, the system for using the service according to the present exemplary embodiment separately includes a solution hub 140, and manages information about the plurality of ISPs by using the solution hub 140.

The solution hub 140 may manage information about servers operated by the plurality of ISPs and may manage a widget which enables the TV 110 to use the services of the plurality of ISPs as the information about the plurality of ISPs. The widget is an example of a software enabling the user to use the services of the plurality of ISPs via the TV 110, and thus the solution hub 140 may manage all types of software including the UI or an application that can be installed in the TV 110 to enable use of the services of the plurality of ISPs.

Probe servers 150 and 170 operate to authenticate which ISP provides an Internet service to the TV 110. The TV 110 receives information about the probe servers 150 and 170 via the solution hub 140, and performs user authentication by attempting to access the probe servers 150 and 170 according to the received information.

In the present exemplary embodiment of FIG. 1, if the TV 110 is provided Internet access from the ISP1, the TV 110 may access the probe server 150 of the ISP1, may perform the user authentication, and may then use a service provided from the ISP1 via a service server 160 of the ISP1. However, although the TV 110 accesses the probe server 170 of the ISP2 via two routers 130 and 132, the TV 110 may not perform the user authentication by accessing the probe server 170, and thus, the TV 110 may not use a service provided from the ISP2 via a service server 180 of the ISP2.

While FIG. 1 corresponds to a case in which a probe server 150 and 170 and a service server 160 and 180 exist as logically or physically distinguished entities in each ISP, it is understood that the probe server 150 and 170 and the service server 160 and 180 may exist as one entity in another exemplary embodiment. In other words, the ISP1 may operate only one server performing operations of both the probe server 150 and the service server 160, and the ISP2 may also operate only one server performing operations of both the probe server 170 and the service server 180. Hereinafter, it is assumed that each of a plurality of ISPs operates one server performing operations of both a probe server and a service server. However, it is understood that a method of using a service, which is to be described later, may also be applied to a case in which a plurality of servers including a server operating as a probe server and another server operating as a service server may exist in an exemplary embodiment.

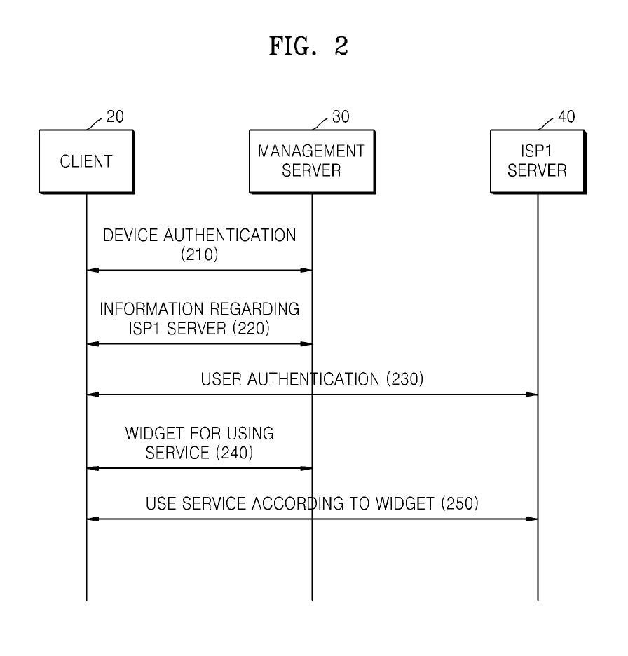

FIG. 2 is a flowchart of a method of using a service, according to an exemplary embodiment. Referring to FIG. 2, in operation 210, a client 20 accesses a management server 30 and performs a device authentication. The client 20 may correspond to the TV 110 of FIG. 1. Furthermore, the management server 30 manages information about an ISP1 and may correspond to the solution hub 140 of FIG. 1.

The management server 30 is a server that manages information regarding a server 40 of the ISP1, and software related to use of a service of the ISP1, so as to allow the client 20 to use the service of the ISP1. Thus, the software may be dependent upon the client 20, and the management server 30 may be operated by a manufacturer so as to support a service use by the client 20, wherein the manufacturer has manufactured the client 20.

In this case, in order to allow the client 20 manufactured by a specific manufacturer to access the management server 30, in operation 210, the management server 30 performs the device authentication so as to check whether the client 20 is a device enabled to receive the information regarding the probe server of the ISP1, and to receive the software from the management server 30. For example, by checking a serial number of the client 20, the management server 30 determines whether the client 20 is a device that has been manufactured by the manufacturer operating the management server 30.

Operation 210 is optional and may be omitted in another exemplary embodiment. For example, in a case where the management server 30 is a general purpose server which all client devices may access regardless of manufacturers, the device authentication in operation 210 may be omitted.

In operation 220, the client 20 receives information regarding the ISP1 server 40 from the management server 30. The client 20 may access the management server 30 according to Uniform Resource Locator (URL) information of the management server 30, which is known or input, and may request URL information of the ISP1 server 40. In a case where a probe server and a service server are separate, as illustrated in FIG. 1, the client 20 requests URL information of the probe server. The request and reception of information regarding the ISP1 server 40 may be performed according to Hyper Text Transfer Protocol (HTTP) as shown in Table 1 below:

TABLE 1

| | |
|---|---|
| Client → | GET infolink.pavv.co.kr/GetIspProbeServers HTTP/1. |
| Management | |
| server | |
| Management | HTTP/1.1 200 OK |
| server → Client | Content-Type: application/x-ispboundservice+xml |
| | Content-Length: 147 |
| | <?xml version=‘1.0’ encoding=‘UTF-8’?> |
| | <ProbeServers> |

<ProbeServer>ISP1.probe.com</ProbeServer>

</ProbeServers>

Referring to Table 1, the client 20 requests an address of the ISP1 server 40 by using a GET method of HTTP. Afterward, the client 20 receives an HTTP response message having a body including the address of the ISP1 server 40 from the management server 30.

In operation 230, the client 20 accesses the ISP1 server 40 based on the information regarding the ISP1 server 40, received in operation 220, and performs a user authentication. Afterward, it is checked whether the client 20 is provided Internet access from the ISP1. As in the case of FIG. 1, when the probe server and the service server are separate, the user authentication in operation 230 may be performed by the probe server 150 of the ISP1.

As described above in relation to FIG. 1, the ISP1 may provide a service that is used by only a user who is provided Internet access from the ISP1. Thus, in order to determine whether the client 20 is a device that is provided Internet access from the ISP1, the user authentication is performed in operation 230.

The client 20 transmits information regarding the client 20 to the ISP1 server 40, and the ISP1 determines whether the client 20 is a device that is provided Internet access from the ISP1, according to the transmitted information. For example, the client 20 may transmit an IP address to the ISP1 server 40. Since the ISP1 has information regarding all IP addresses that the ISP1 allocates, if an IP address of the client 20 is one of the IP addresses that the ISP1 allocates, the ISPa may authenticate that the client 20 is a device to be provided Internet access from the ISP1.

Also, the client 20 may transmit a user identifier (ID) and a Universally Unique ID (UUID) to the ISP1 server 40. The user ID may be an ID input in a log-in operation so as to be provided Internet access.

As a result of the determination performed by the ISP1 server 40 according to the received information regarding the client 20, for example, at least one of the IP address, the user ID and the UUID, the ISP1 transmits a response message indicating authentication of the client 20 to the client 20, and the user authentication in operation 230 is complete.

Operations 240 and 250 are operations in which the client 20 that has undergone the user authentication in operation 230 uses a service of the ISP1.

Specifically, in operation 240, the client 20 receives software for using the service of the ISP1 from the management server 30. The client 20 may request the management server 30 to provide the software for using the service of the ISP1, and as a response to the request, the client 20 may receive the software. The software may include, for example, at least one of a widget for using the service of the ISP1, a UI and an application.

If there are a plurality of widgets for using the service of the ISP1, the ISP1 server 40 may provide a list of the plurality of widgets to the client 20 according to a software request from the client 20, and the client 20 may sequentially receive the plurality of widgets included in the list. Table 2 below shows an example of a list of a plurality of widgets:

TABLE 2

| | | |
|---|---|---|
| Client → | GET | infolink.paw.co.kr/ |

| | |
|---|---|
| Management | GetIspWidgetList?isp=ISP1.probe.com HTTP/1.1 |
| server | |
| Management | HTTP/1.1 200 OK |
| server → Client | Content-Type: application/x-ispboundservice+xml |
| | Content-Length: 142 |
| | <?xml version=‘1.0’ encoding=‘UTF-8’?> |
| | <ISPWidgets> |

<ISPWidget>1111</ISPWidget>
<ISPWidget>1112</ISPWidget>
<ISPWidget>1113</ISPWidget>

</ISPWidgets>

Referring to Table 2, when the client 20 transmits a message by using a GET method of HTTP so as to request information regarding a widget for using the service of the ISP1, the management server 30 may transmit the list of the plurality of widgets corresponding to 1111, 1112 and 1113 to the client 20. Accordingly, the client 20 may receive the plurality of widgets from the management server 30 according to the list.

In operation 250, the client 20 uses the service of the ISP1 based on the software received from the management server 30 in operation 240. The client 20 may install the received software (e.g., the received widget), and may use the service of the ISP1 based on the installed software. The service may be an IPTV service.

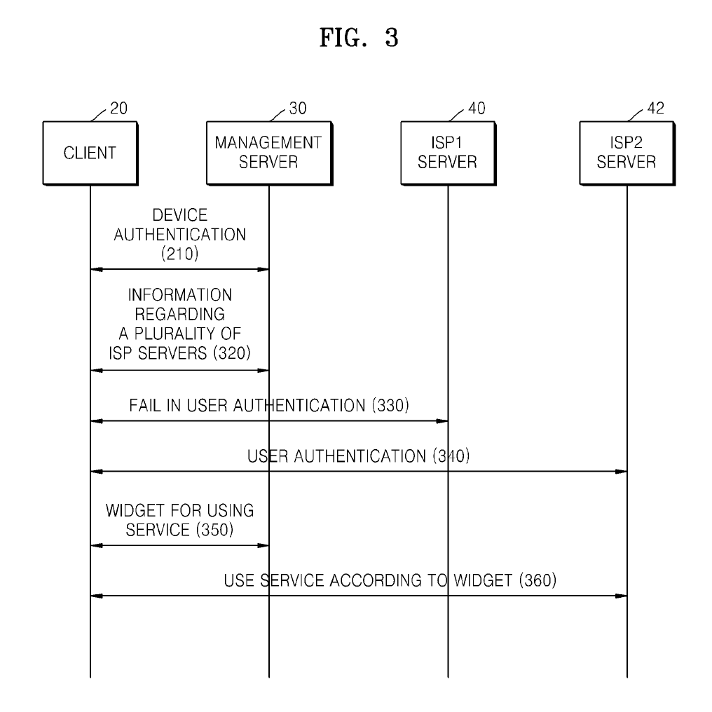

FIG. 3 is a flowchart of a method of using a service, according to another exemplary embodiment. When a plurality of ISPs exist, FIG. 3 illustrates a method including searching for an ISP, from among the plurality of ISPs, providing Internet access to a client 20, and then using a service of the ISP that is searched for.

Referring to FIG. 3, in operation 310, the client 20 accesses a management server 30, and performs device authentication. Operation 310 is similar to operation 210 of FIG. 2, and may be omitted in another exemplary embodiment.

In operation 320, the client 20 receives information regarding a plurality of ISP servers from the management server 30. The client 20 may access the management server 30 based on URL information regarding the management server 30 which is already known or input to the client 20, may request URL information regarding the plurality of ISP servers operated by the plurality of ISPs, and may receive the information. In a case where the probe server and the service server are separate, as illustrated in FIG. 1, the client 20 may receive URL information regarding a plurality of probe servers. As shown in Table 3 below, in an exemplary embodiment, the URL information regarding the plurality of probe servers may be received according to HTTP:

TABLE 3

| | |
|---|---|
| Client → | GET infolink.pavv.co.kr/GetIspProbeServers HTTP/1. |
| Management | |
| server | |
| Management | HTTP/1.1 200 OK |
| server → Client | Content-Type: application/x-ispboundservice+xml |
| | Content-Length: 147 |
| | <?xml version=‘1.0’ encoding=‘UTF-8’?> |
| | <ProbeServers> |

<ProbeServer>ISP1.probe.com</ProbeServer>
<ProbeServer>ISP2.probe.com</ProbeServer>

</ProbeServers>

In a case where the plurality of ISPs may provide Internet access to the client 20, as in the present exemplary embodiment, the ISP that provides Internet access to the client 20 is unknown when the client 20 is manufactured. Thus, an ISP providing Internet access to the client 20 is searched by performing a user authentication in operations 330 and 340, wherein the ISP is from among the plurality of ISPs. Specifically, in operation 320, the management server 30 transmits information regarding the plurality of ISP servers to the client 20. For example, referring to Table 3, URL information regarding a probe server of an ISP1 and a probe server of an ISP2 is included in a body of an HTTP message transmitted from the management server 30 to the client 20.

In operations 330 and 340, the ISP, from among the plurality of ISPs, providing Internet access to the client 20 is searched for. The client 20 attempts to sequentially access the plurality of ISP servers according to the URL information regarding the plurality of ISP servers received in operation 320, and searches for the ISP providing Internet access to the client 20.

In operation 330, the client 20 accesses the ISP1 server 40 according to the URL information regarding the plurality of ISP servers, wherein the URL information is received in operation 320, and then attempts to perform the user authentication. As described above, the client 20 may attempt to perform the user authentication by transmitting, for example, at least one of the IP address, the user ID and the UUID to the ISP1 server 40. As a result of the attempted user authentication, if the client 20 is not a device being provided Internet access from the ISP1, the user authentication fails.

The client 20 that has failed in the user authentication in operation 330 attempts to perform user authentication by accessing an ISP2 server 42 in operation 340. If the client 20 is a device being provided Internet access from the ISP2, the client 20 succeeds in the user authentication.

Messages exchanged between the client 20, the ISP1 server 40, and the ISP2 server 42 in operations 330 and 340 may be messages according to an HTTP as shown in Table 4 below:

TABLE 4

| | |
|---|---|
| Client → ISP1 | GET ISP1.probe.com/AmIBoundServiceUser HTTP/1.1 |
| server | |
| ISP1 server → | HTTP/1.1 404 Not Found |
| Client | |
| Client → ISP2 | GET ISP2.probe.com/AmIBoundServiceUser HTTP/1.1 |
| server | |
| ISP2 server → | HTTP/1.1 200 OK |
| Client | |

Referring to Table 4, in operation 330, the client 20 attempts to perform the user authentication by transmitting a “GET ISP1.probe.com/AmIBoundServiceUser HTTP/1.1” message to the ISP1 server 40. However, the client 20 fails in the user authentication and thus receives a “HTTP/1.1 404 Not Found” message from the ISP1 server 40. Afterward, in operation 340, the client 20 attempts to perform the user authentication by transmitting a “GET ISP2.probe.com/AmIBoundServiceUser HTTP/1.1” message to the ISP2 server 42. In response, the client 20 receives a “HTTP/1.1 200 OK” message indicating a success of the user authentication from the ISP2 server 42.

In a case where a probe server and a service server are separate, as illustrated in FIG. 1, the user authentication in operations 330 and 340 may be respectively performed by the probe server of the ISP1 and the probe server of the ISP2.

In operations 350 and 360, the client 20 uses a service of the ISP searched for and found in operations 330 and 340.

In operation 350, the client 20 receives software for using a service of the ISP2 from the management server 30. The client 20 may request the management server 30 for the software for using the service of the ISP2, and as a response to the request, the client 20 may receive the software. Operation 350 is similar to operation 240 of FIG. 2.

In operation 360, the client 20 uses the service of the ISP2 based on the software received from the management server 30 in operation 350. Operation 360 is similar to operation 250 of FIG. 2.

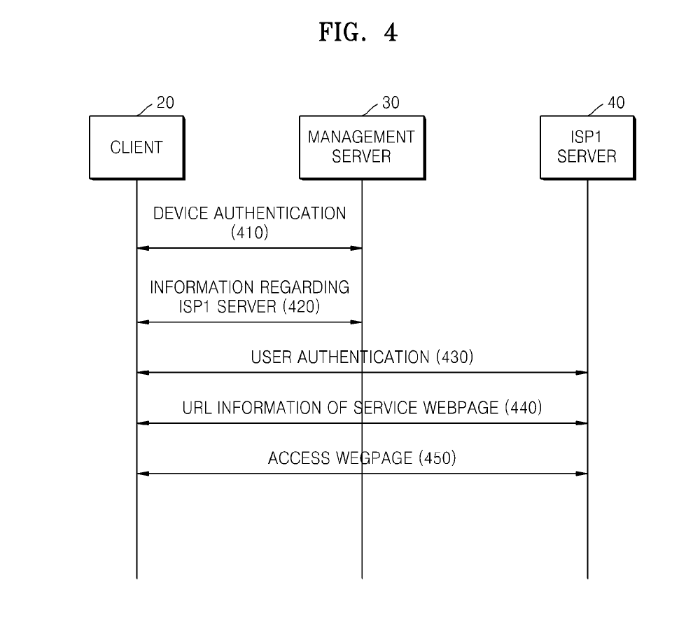

FIG. 4 is a flowchart of a method of using a service, according to another exemplary embodiment. FIG. 4 corresponds to a case in which separate software for using a service is not used, but a client 20 uses a service of an ISP by accessing a webpage providing the service of the ISP via a web browser.

Referring to FIG. 4, in operation 410, the client 20 performs a device authentication by accessing a management server 30. Operation 410 is similar to operation 210 of FIG. 2, and may be omitted in another exemplary embodiment.

In operation 420, the client 20 receives information regarding an ISP1 server 40 from the management server 30. Operation 420 is similar to operation 220 of FIG. 2.

In operation 430, the client 20 performs a user authentication by accessing the ISP1 server 40 according to the information regarding the ISP1 server 40 received in operation 420. Operation 430 is similar to operation 230 of FIG. 2.

In operations 440 and 450, the client 20 that has performed the user authentication uses the service of the ISP1.

Specifically, in operation 440, the client 20 receives URL information of a webpage related to the service of the ISP1 from the ISP1 server 40. The client 20 receives the URL information of the webpage through which the client 20 may be provided the service of the ISP1. FIG. 4 corresponds to a case in which the URL information of the webpage related to the service of the ISP1 is received in operation 440 that is separate from operation 430 in which the user authentication is performed. However, when the user authentication is performed in operation 430, the URL information of the webpage related to the service of the ISP1 may also be received therewith.

In operation 430, when the client 20 transmits information regarding the client 20 to the ISP1 server 40, and the ISP1 server 40 checks the transmitted information so that the client 20 is authenticated as a device being provided Internet access from the ISP1, the ISP1 server 40 transmits a response message to the client 20 that indicates that the client 20 is authenticated. Here, the response message may include the URL information of the webpage related to the service of the ISP1, an example of which is described detail with reference to Table 5 below:

TABLE 5

| | |
|---|---|
| Client → | GET ISP1.probe.com/AmIBoundServiceUser HTTP/1.1 |
| ISP1 server | |

| | |
|---|---|
| ISP1 server → | HTTP/1.1 200 OK |
| Client | Content-Type: application/x-ispboundservice+xml |
| | Content-Length: 860 |
| | <?xml version=‘1.0’ encoding=‘UTF-8’?> |
| | <ServiceDiscovery > |
| | < ServiceProvider DomainName=“kt.co.kr” |

Version=“01”
LogoURI=http://kt.co.kr/logo/kt_logo_img.png
StartPage=http://kt.co.kr/ISP-bound/MainIndex.html>
KT</ServiceProvider>

<ServiceName Language=“eng”>KT ISP Bound

Service</ ServiceName >
<Description Language=“eng”>KT IPTV
Solution</Description>

<ServiceDiscovery >

Referring to Table 5, in operation 430, when the client 20 requests the user authentication to the ISP1 server 40 by using a GET method of HTTP, and the client 20 is authenticated as the device being provided Internet access from the ISP1, the ISP1 server 40 transmits, to the client 20, the response message, which indicates the authentication of the client 20. The response message further includes “http://kt.co.kr/ISP-bound/MainIndex.html,” which is the URL information of the webpage related to the service of the ISP1.

In operation 450, the client 20 accesses the webpage according to the URL information related to the service of the ISP1 which is received in operation 430 or operation 440, and uses the service of the ISP1.

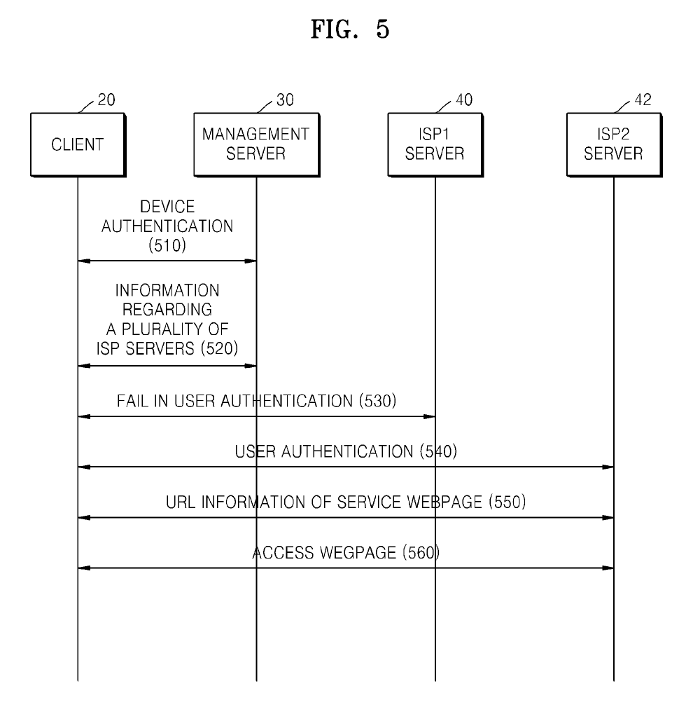

FIG. 5 is a flowchart of a method of using a service, according to another exemplary embodiment. Referring to FIG. 5, in operation 510, a client 20 accesses a management server 30 and performs a device authentication. Operation 510 is similar to operation 310 of FIG. 3, and may be omitted in another exemplary embodiment.

In operation 520, the client 20 receives URL information regarding a plurality of ISP servers from the management server 30. Operation 520 is similar to operation 320 of FIG. 3,

In operations 530 and 540, an ISP, from among a plurality of ISPs, providing Internet access to the client 20 is searched for. The client 20 searches for the ISP providing Internet access to the client 20 by sequentially attempting to access the plurality of ISP servers according to the URL information regarding the plurality of ISP servers, wherein the URL information is received in operation 520. Operations 530 and 540 are similar to operations 330 and 340 of FIG. 3.

In operation 550, the client 20 receives URL information of a webpage related to a service of an ISP2 from an ISP2 server 42, wherein the URL information is searched for in operations 530 and 540. The URL information of the webpage related to the service of the ISP2 may be separately received in operation 550, or the URL information of the webpage related to the service of the ISP2 may be received in operation 540 in which the user authentication is performed, an example of which is described in detail with reference to Table 6:

TABLE 6

| | |
|---|---|
| Client → ISP1 | GET ISP1.probe.com/AmIBoundServiceUser HTTP/1.1 |
| server | |
| ISP1 server → | HTTP/1.1 404 Not Found |
| Client | |
| Client → ISP2 | GET ISP2.probe.com/AmIBoundServiceUser HTTP/1.1 |
| server | |
| ISP2 server → | HTTP/1.1 200 OK |
| Client | Content-Type: application/x-ispboundservice+xml |
| | Content-Length: 860 |
| | <?xml version=‘1.0’ encoding=‘UTF-8’?> |
| | <ServiceDiscovery > |
| | < ServiceProvider DomainName=“kt.co.kr” |
| | Version=“01” |
| | LogoURI=http://kt.co.kr/logo/kt_logo_img.png |
| | StartPage=http://kt.co.kr/ISP-bound/MainIndex.html> |
| | KT</ServiceProvider> |

<ServiceName Language=“eng”>KT ISP

Bound Service</ ServiceName >

<Description Language=“eng”>KT IPTV

Solution</Description>

<ServiceDiscovery >

Referring to Table 6, in operation 530, the client 20 attempts to perform the user authentication by transmitting a “GET ISP1.probe.com/AmIBoundServiceUser HTTP/1.1” message to an ISP1 server 40. However, the client 20 fails in the user authentication and thus receives a “HTTP/1.1 404 Not Found” message from the ISP1 server 40. Subsequently, in operation 540, the client 20 attempts to perform the user authentication by transmitting a “GET ISP2.probe.com/AmIBoundServiceUser HTTP/1.1” message to the ISP2 server 42. When the client 20 is authenticated as a device being provided Internet access from the ISP2, the ISP2 server 42 transmits, to the client 20, a response message, which indicates the authentication of the client 20. The response message further includes “http://kt.co.kr/ISP-bound/MainIndex.html,” which is the URL information of the webpage related to the service of the ISP2.

In operation 560, the client 20 accesses the webpage according to the URL information related to the service of the ISP2 which is received in operation 540 or operation 550, and uses the service of the ISP2.

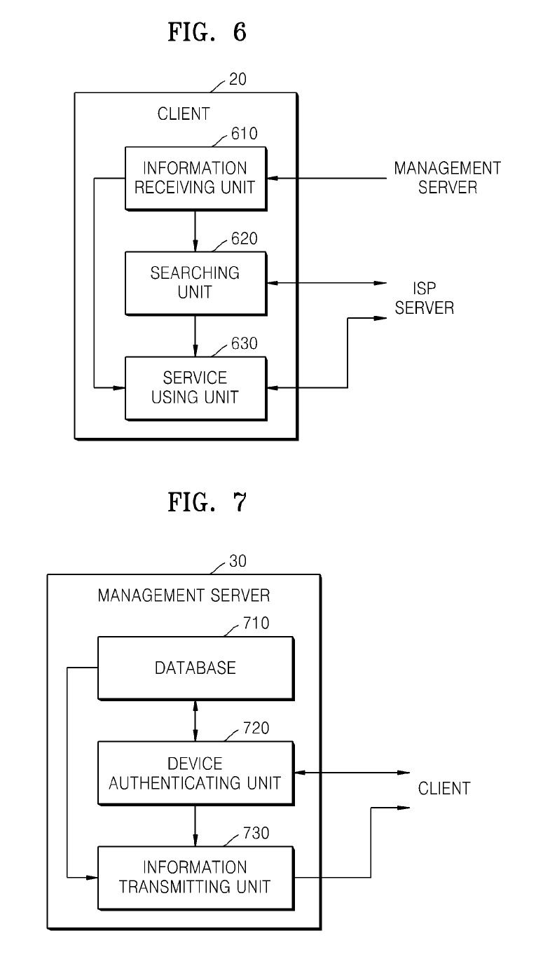

FIG. 6 is a diagram of a client 20 according to another exemplary embodiment. Referring to FIG. 6, the client 20 includes an information receiving unit 610, a searching unit 620, and a service using unit 630.

The information receiving unit 610 receives information regarding an ISP server or a plurality of ISP servers from a management server 30. For example, the information receiving unit 610 may receive URL information regarding an ISP server. In a case where a probe server and a service server are separate, as illustrated in FIG. 1, the information receiving unit 610 may receive URL information regarding a plurality of probe servers.

The searching unit 620 searches for an ISP providing Internet access to the client 20, according to the information regarding the plurality of ISP servers, wherein the information is received by the information receiving unit 610. As illustrated in FIGS. 3 and 5, the searching unit 620 may attempt to access the plurality of ISP servers, and searches for the ISP. The client 20 sequentially transmits information about the client 20 to the plurality of ISP servers, and receives a response message from a server of the ISP providing Internet access to the client 20, wherein the response message indicates that a user is authenticated. The information about the client 20, which is transmitted to the plurality of ISP servers, may include, for example, at least one of an IP address of the client 20, a user ID, and a QUID.

The service using unit 630 uses a service of an ISP with which a successful user authentication is performed. In a case where the searching unit 620 has searched for and found an ISP providing Internet access to the client 20 from among the plurality of ISPs, the service using unit 630 uses a service of the found ISP.

As described with reference to FIGS. 2 and 3, when separate software is used to use a service of an ISP, software for using the service of the found ISP is received from the management server 30 via the information receiving unit 610, and the service of the found ISP is used by using the received software. The software may include at least one of a widget, a UI, an application, etc.

As described with reference to FIGS. 4 and 5, when the client 20 accesses a predetermined webpage so as to use a service of an ISP, the client 20 receives URL information of the webpage related to the service from the ISP with which the successful user authentication is performed, accesses the webpage according to the received URL information, and then uses the service.

FIG. 7 is a diagram of a management server 30 according to another exemplary embodiment. Referring to FIG. 7, the management server 30 includes a database 710, a device authenticating unit 720, and an information transmitting unit 730.

The database 710 stores information regarding an ISP server or a plurality of ISP servers. In a case where a probe server and a service server are separate, the database 710 may store URL information of the probe server.

In addition, the database 710 may store software to use a service of the ISP server or the plurality of ISP servers. The database 710 stores the software including, for example, at least one of a widget, a UI, an application, etc., which is used to use the service of the ISP. When the client 20 requests the software to use a service of a specific ISP, the database 710 transmits the requested software to the client 20 via the information transmitting unit 730.

The device authenticating unit 720 performs a device authentication on the client 20. That is, the device authenticating unit 720 performs the device authentication so as to check whether the client 20 is a device enabled to receive the information regarding the ISP server, and the software. As described above with reference to FIG. 2, the device authentication may be omitted in another exemplary embodiment.

The information transmitting unit 730 transmits the information regarding the ISP server or the plurality of ISP servers to the client 20, wherein the information is stored in the database 710. In a case where the client 20 uses separate software so as to use the service of the ISP, the software stored in the database 710 may be transmitted to the client 20.

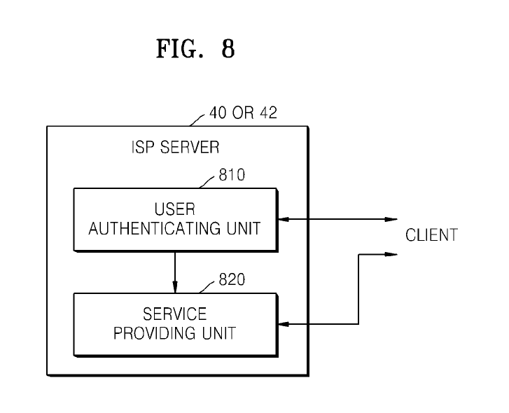

FIG. 8 is a diagram of an ISP server according to another exemplary embodiment. Referring to FIG. 8, the ISP server (e.g., the ISP1 server 40 or the ISP2 server 42) includes a user authenticating unit 810 and a service providing unit 820.

The user authenticating unit 810 performs a user authentication by receiving information regarding the client 20 from the client 20. The user authenticating unit 810 determines whether the client 20 is a device that is provided Internet access from an ISP operating the ISP server 40 or 42. The information about the client 20 may include, for example, at least one of an IP address of the client 20, a user ID, a UUID, etc.

The service providing unit 820 provides a service to the client 20 that is user-authenticated by the user authenticating unit 810.

According to exemplary embodiments, a client may actively search for an ISP providing Internet access to the client from among a plurality of ISPs, and may use a service of the searched ISP, so that it is possible to increase utilization of the client.

While exemplary embodiments have been particularly shown and described with reference to the drawings, it will be understood by those of ordinary skill in the art that various changes in form and details may be made therein without departing from the spirit and scope of the present invention as defined by the following claims. Also, while not restricted thereto, an exemplary embodiment may be embodied as computer readable codes on a computer readable recording medium.

For example, the client, the management server, and the ISP server according to the one or more exemplary embodiments may respectively include a bus coupled to each unit illustrated in FIGS. 6 through 8, and at least one processor coupled to the bus. Also, the client, the management server, and the ISP server according to one or more exemplary embodiments may include a memory combined with the bus so as to store at least one of commands, received messages, and generated messages, and then coupled to the at least one processor for executing the commands.

The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

What is claimed is:

1. A method of using a service of an Internet Service Provider (ISP) from among a plurality of ISPs, wherein the method is performed by a client, the method comprising:
receiving information regarding a plurality of servers respectively operated by the plurality of ISPs from a server managing information regarding the plurality of ISPs;
searching for an ISP which provides Internet access to the client from among the plurality of ISPs by accessing at least one of the plurality of servers according to the received information; and
using a service of the ISP which provides the Internet access to the client and is discovered based on the searching.

2. The method of claim 1, wherein the searching comprises:
sequentially transmitting information regarding the client to the plurality of servers according to the received information regarding the plurality of servers; and
receiving a message indicating a successful authentication of the client from a server of the discovered ISP which provides the Internet access to the client.

3. The method of claim 2, wherein the information regarding the client comprises at least one of an Internet Protocol address of the client, a user identifier (ID), and a Universally Unique ID.

4. The method of claim 1, wherein the using the service comprises:
receiving a widget for using the service of the searched ISP from the server managing the information regarding the plurality of ISPs;
installing the received widget; and
using the service of the discovered ISP which provides the Internet access to the client according to the installed widget.

5. The method of claim 4, wherein the receiving the widget comprises:
transmitting information regarding the discovered ISP which provides the Internet access to the client to the server managing the information regarding the plurality of ISPs;
receiving a list of a plurality of widgets for using the service of the discovered ISP; and
sequentially receiving the plurality of widgets according to the list of the plurality of widgets.

6. The method of claim 1, wherein the using the service comprises:
receiving location information of a webpage related to the service of the discovered ISP which provides the Internet access to the client from a server operated by the searched ISP; and
accessing the webpage based on the URL information, and using the service of the discovered ISP which provides the Internet access to the client according to the accessed webpage.

7. The method of claim 1, wherein the receiving the information regarding the plurality of servers comprises:
performing a device authentication between the client and the server managing information regarding the plurality of ISPs; and
receiving the information regarding the plurality of servers in response to the device authentication being performed successfully.

8. The method of claim 2, wherein the receiving the message indicating the successful authentication comprises receiving, together with the message indicating the successful authentication, location information of a webpage related to the service of the discovered ISP from the server of the discovered ISP.

9. The method of claim 1, wherein the using the service comprises:
receiving at least one of a user interface (UI) and an application for using the service of the discovered ISP from the server managing the information regarding the plurality of ISPs; and
using the service of the discovered ISP according to the at least one of the UI and the application.

10. The method of claim 1, wherein the using the service comprises:
transmitting information regarding the discovered ISP providing the Internet access to the client to the server managing the information regarding the plurality of ISPs;
receiving software for using the service of the discovered ISP from the server managing the information regarding the plurality of ISPs; and
using the service of the discovered ISP according to the received widget.

11. The method of claim 1, wherein the service is an Internet Protocol television service.

12. An apparatus for using a service of an Internet Service Provider (ISP) from among a plurality of ISPs, wherein the apparatus is implemented in a client, the apparatus comprising:
an information receiving unit which receives information regarding a plurality of servers respectively operated by the plurality of ISPs from a server managing information regarding the plurality of ISPs;
a searching unit which searches for an ISP providing Internet access to the client from among the plurality of ISPs by accessing at least one of the plurality of servers according to the received information; and
a service using unit which uses a service of the ISP which provides the Internet access to the client and is discovered by the searching performed by the searching unit.

13. The apparatus of claim 12, wherein the searching unit sequentially transmits information regarding the client to the plurality of servers according to the received information regarding the plurality of servers, and receives a message indicating a successful authentication of the client from a server of the discovered ISP which provides the Internet access to the client.

14. The apparatus of claim 13, wherein the information regarding the client comprises at least one of an Internet Protocol address of the client, a user identifier (ID), and a Universally Unique ID.

15. The apparatus of claim 12, wherein the service using unit receives a widget for using the service of the discovered ISP from the server managing the information regarding the plurality of ISPs, installs the received widget, and uses the service of the discovered ISP which provides the Internet access to the client according to the installed widget.

16. The apparatus of claim 15, wherein the service using unit transmits information regarding the discovered ISP which provides the Internet access to the client to the server managing the information regarding the plurality of ISPs, receives a list of a plurality of widgets for using the service of the discovered ISP, and sequentially receives the plurality of widgets according to the list of the plurality of widgets.

17. The apparatus of claim 12, wherein the service using unit receives location information of a webpage related to the service of the discovered ISP which provides the Internet access to the client from a server operated by the searched ISP, and accesses the webpage based on the URL information, and uses the service of the discovered ISP which provides the Internet access to the client according to the accessed webpage.

18. A method of using a service of an Internet Service Provider (ISP), wherein the method is performed by a client, the method comprising:
receiving information regarding a server operated by the ISP from a server managing information regarding the ISP;
determining whether the ISP provides Internet access to the client by accessing the ISP according to the received information; and
using a service of the ISP in response to determining that the ISP provides the Internet access to the client.

19. A computer readable recording medium having recorded thereon a program for executing the method of claim 1.

20. A computer readable recording medium having recorded thereon a program for executing the method of claim 18.
